(19) United States
(12) Patent Application Publication
(10) Pub. No.: US 2025/0225344 A1
(43) Pub. Date: Jul. 10, 2025

(54) BIDIRECTIONAL COMMUNICATION WITH INFRASTRUCTURE AS CODE SYSTEM

(71) Applicant: Tencent America LLC, Palo Alto, CA (US)

(72) Inventors: Tim LI, Palo Alto, CA (US); Yuhao QIU, Palo Alto, CA (US); Shiwei LIU, San Jose, CA (US)

(73) Assignee: Tencent America LLC, Palo Alto, CA (US)

(21) Appl. No.: 19/007,311

(22) Filed: Dec. 31, 2024

Related U.S. Application Data
(60) Provisional application No. 63/618,191, filed on Jan. 5, 2024.
(60) Provisional application No. 63/618,860, filed on Jan. 8, 2024.

(51) Int. Cl. G06F 40/58; G06F 40/205; H04L 41/084

(52) U.S. Cl. CPC G06F 40/58; G06F 40/205; H04L 41/084

(57) ABSTRACT

A method is provided, in which infrastructure configuration parameters received from a configuration management database are converted into an infrastructure-as-code configuration language file. Infrastructure configuration modifications are applied to the infrastructure-as-code configuration language file. The modified infrastructure-as-code configuration language file is forwarded to an infrastructure-as-a-service provider. Provisional infrastructure-as-code parameters output by the infrastructure-as-a-service provider in response to the modified infrastructure-as-code configuration language file are converted to updated infrastructure configuration parameters. The updated infrastructure configuration parameters are transmitted for storage in the configuration management database.

### INCORPORATION BY REFERENCE

The present application claims the benefit of priority to U.S. Provisional Application No. 63/618,191, “SSOT PROTOCOL FOR IAC” filed on Jan. 5, 2024, which is incorporated by reference herein in its entirety.

### TECHNICAL FIELD

The present disclosure describes aspects generally related to protocol design, including in cloud computing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Cloud computing can refer to the on-demand availability of computer system resources, especially data storage (cloud storage) and computing power. Cloud computing services can provide environments for customers to develop, run, and manage web applications without the complexity of building and maintaining any infrastructure associated with developing and launching the applications. Examples of cloud computing services include infrastructure as a service (IaaS), platform as a service (PaaS), software as a service (SaaS) and the like. The present disclosure may also refer to IaaS as infrastructure-as-a-service, refer to PaaS as platform-as-a-service, and SaaS as software-as-a-service.

In some related cloud computing examples, infrastructure as code (IaC) is manually written, cloud resources are manually created/deployed, messages are manually entered into a configuration management database (CMDB), and the CMDB is manually synchronized with deployed cloud resources.

### SUMMARY

In related cloud computing examples, the landscape of IaC solutions lacks unified specifications and standards. Further, the development process in the IaC sector is rudimentary and disorganized, characterized by a lack of coherence and a prevalence of unconventional approaches. The absence of standardized protocols in the IaC sector can result in solutions that are often inconsistent and unpredictable, hindering efficient and streamlined development.

According to an aspect of the disclosure, a method is provided. In the method, infrastructure configuration parameters received from a configuration management database are converted into an infrastructure-as-code configuration language file. Infrastructure configuration modifications are applied to the infrastructure-as-code configuration language file. The modified infrastructure-as-code configuration language file is forwarded to an infrastructure-as-a-service provider. Provisional infrastructure-as-code parameters, output by the infrastructure-as-a-service provider in response to the modified infrastructure-as-code configuration language file, are converted to updated infrastructure configuration parameters. The updated infrastructure configuration parameters are transmitted for storage in the configuration management database.

In an aspect, the conversion of the infrastructure configuration parameters is performed by parsing and transcribing the infrastructure configuration parameters stored in the configuration management database into the infrastructure-as-code configuration language file.

In an aspect, the conversion of the provisional infrastructure-as-code parameters is performed by parsing and transcribing the provisional infrastructure-as-code parameters output by the infrastructure-as-a-service provider into the updated infrastructure configuration parameters.

In an aspect, the infrastructure-as-code configuration language file includes a Terraform file.

In an aspect, the configuration management database is part of a software-as-a-service platform.

In an aspect, the infrastructure configuration parameters received from the configuration management database include at least one of asset configuration parameters, resource definition parameters, topology hierarchy parameters, or organizational structure parameters.

In an aspect, the infrastructure configuration parameters stored in the configuration management database are a single source of truth (SSOT) of infrastructure data.

In an aspect, the infrastructure-as-code configuration language file is displayed in a graphical user interface (GUI). The infrastructure configuration modifications are received through the GUI.

In an aspect, the conversion of the infrastructure configuration parameters is triggered by at least one of a user request, an event-based trigger, or at a time-based interval.

According to another aspect of the disclosure, an apparatus is provided. The apparatus is an information processing apparatus, for example. The apparatus includes processing circuitry. The processing circuitry can be configured to perform any of the described methods.

In an aspect, the apparatus includes processing circuitry configured to convert infrastructure configuration parameters received from a configuration management database into an infrastructure-as-code configuration language file. The processing circuitry is configured to apply infrastructure configuration modifications to the infrastructure-as-code configuration language file. The processing circuitry is configured to forward the modified infrastructure-as-code configuration language file to an infrastructure-as-a-service provider. The processing circuitry is configured to convert, to updated infrastructure configuration parameters, provisional infrastructure-as-code parameters output by the infrastructure-as-a-service provider in response to the modified infrastructure-as-code configuration language file. The processing circuitry is configured to transmit the updated infrastructure configuration parameters for storage in the configuration management database.

In an aspect, the processing circuitry is configured to convert the infrastructure configuration parameters by parsing and transcribing the infrastructure configuration parameters stored in the configuration management database into the infrastructure-as-code configuration language file.

In an aspect, the processing circuitry is configured to convert the provisional infrastructure-as-code parameters by parsing and transcribing the provisional infrastructure-as-code parameters output by the infrastructure-as-a-service provider into the updated infrastructure configuration parameters.

In an aspect, the infrastructure-as-code configuration language file includes a Terraform file.

In an aspect, the configuration management database is part of a software-as-a-service platform.

In an aspect, the infrastructure configuration parameters received from a configuration management database include at least one of asset configuration parameters, resource definition parameters, topology hierarchy parameters, or organizational structure parameters.

In an aspect, the infrastructure configuration parameters stored in the configuration management database are a single source of truth (SSOT) of infrastructure data.

In an aspect, the processing circuitry is further configured to display the infrastructure-as-code configuration language file in a graphical user interface (GUI), and receive the infrastructure configuration modifications through the GUI.

In an aspect, the processing circuitry is configured to convert the infrastructure configuration parameters in response to at least one of a user request, an event-based trigger, or at a time-based interval.

Aspects of the disclosure also provide a non-transitory computer-readable medium storing instructions which, when executed by a computer, cause the computer to perform any of the described methods.

### BRIEF DESCRIPTION OF THE DRAWINGS

Further features, the nature, and various advantages of the disclosed subject matter will be more apparent from the following detailed description and the accompanying drawings in which:

FIG. 1 is a comparison table that compares a related example with a protocol example according to aspects of the present disclosure.

FIG. 2 is a screenshot illustrating a user interface of a platform for managing CMDB metadata.

FIG. 3 is a diagram of a computing architecture including a software as a service (SaaS) layer, a protocol layer, an infrastructure as code (IaC) layer, and an infrastructure as a service (IaaS) layer.

FIG. 4 shows a portion of code showing that, once infrastructure changes are applied via Terraform, the output-definitions are fed back into the CMDB via a RESTful API local-exec provisioner.

FIG. 5 shows an example of a Lexer component using regular expressions.

FIG. 6 shows an example parser component that defines rules that dictate how tokens can be combined to form valid syntactic constructs.

FIG. 7 shows an example of Terraform syntax to CMDB in an aspect of the disclosure.

FIG. 8 is a diagram of CMDB metadata structure from RESTful API in an aspect of the disclosure.

FIG. 9 shows an example of a cmdb_extra.tfvars protocol message structure definition in an aspect of the disclosure.

FIG. 10 shows an example of field definitions of the IaC mapping schema of FIG. 9.

FIG. 11 shows an example of code to transcribe CMDB metadata to Terraform in an aspect of the disclosure.

FIG. 12 is a diagram of a protocol message file conversion sequence in an aspect of the disclosure.

FIG. 13 is a diagram of a state control mechanism in an aspect of the disclosure.

FIGS. 14A and 14B include a diagram of the structural composition of IaC.json file format according to some aspects of the disclosure.

FIG. 15 shows details of the structural composition of IaC.json file format according to some aspects of the disclosure.

FIG. 16 shows details of the structural composition of IaC.json file format according to some aspects of the disclosure.

FIG. 17 shows details of the structural composition of IaC.json file format according to some aspects of the disclosure.

FIG. 18 shows details of the structural composition of IaC.json file format according to some aspects of the disclosure.

FIG. 19 shows an example of IaC.json script definition method according to an aspect of the disclosure.

FIG. 20 shows an example of IaC.json script execution method according to an aspect of the disclosure.

FIG. 21 shows a flow chart outlining a conversion process according to some aspects of the disclosure.

FIG. 22 is a schematic illustration of a computer system in accordance with an aspect.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, these concepts may be practiced without these specific details.

Any descriptions of terms in this disclosure are provided as examples only and are not intended to limit the scope of the disclosure. In the present disclosure, some technical terms are used with the following example definitions.

Zero-dependency refers to the ability of a method to operate independently without relying on external dependencies or middle platforms. Zero-dependency in the present disclosure indicates the capability of some aspects of the present disclosure to function independently of external platforms or environments.

De-middle-platforming refers to the process or methodology involved in eliminating reliance on middle/external platforms, particularly referencing removal of dependencies from intermediary systems, such as intermediary systems communicating between application development terminals and cloud storage. The present disclosure applies principles of de-middle-platforming to reduce unnecessary complexity and redundancy.

Rest4DB refers to a library that provides RESTful interfaces or methods for database operations, encompassing CRUD (Create, Read, Update, Delete) and transaction functionalities.

Runtime-CI/CD denotes continuous integration and continuous deployment (CI/CD) processes executed during the runtime or operation of the application, allowing continuous updates and improvements without interrupting operation of the application.

LoneSail refers to a zero-dependency de-middle-platform runtime-CI/CD method, such as described in U.S. patent application Ser. No. 18/614,545 filed on Mar. 22, 2024, which is incorporated by reference herein in its entirety. In some examples, LoneSail furnishes an intuitive graphical user interface (GUI) designed for oversight of transcription/parsing to preserve message integrity and consistency throughout the exchange between the CMDB and the protocol provided in the present disclosure.

Infrastructure as a service (IaaS) includes a cloud computing service model in which a cloud computing provider provides the computing infrastructure, such as the virtualization, servers, storage, and networking facilities on demand for a customer. The customer can pay for the computing resource that the customer uses, thereby avoiding the expense and complexity of buying and maintaining infrastructure resources. Each customer can rent hardware resources separately and the cloud computing provider is responsible for managing and maintaining those hardware resources. A customer can manage, install, configure, and update its own software, operating system, middleware, data, and applications on the rented hardware resources.

Further, platform as a service (PaaS) includes a cloud computing service model in which a cloud computing provider offers provisioning and hosting capabilities for a developer (e.g., a customer) to develop, host, and deploy applications (e.g., web applications), thereby saving developers from maintaining, configuring, and managing the underlying hardware, software, and hosting capabilities. The developer's application can operate on one or more virtual machines (VMs) running on top of a hypervisor in a host server of the cloud computing provider. The cloud computing provider can manage the runtime, middleware, operating system, virtualization, servers, storage, and networking facilities, and the developer can maintain its applications.

Cloud computing is based on a client-server model, for example. The client-server model is a distributed structure that partitions tasks or workloads between service requesters and providers. The providers of a resource or service are also referred to as servers in some examples, and the service requesters are also referred to as clients in some examples. In some examples, a server can run one or more server programs, and can share resources with clients. A client usually does not share any of its resources, but requests content or service from a server. Clients can initiate communication sessions with servers, which await incoming requests.

In a cloud computing architecture, the front-end can refer to the client side, and the back-end can refer to the server side. The front-end can include user interfaces, and applications that are used by the client to access the cloud computing services. For example, the front-end can include a web browser to access a cloud computing platform. The back-end can include cloud servers and their applications, databases, operating systems, and the like.

Some aspects of the present disclosure provide a general and extensible protocol designed for the exchange, parsing, and transcription of IaC configuration code, including but not limited to Terraform's HashiCorp-Configuration-Language (HCL), between IaaS and SaaS (for example, a CMDB), through RESTful API over HTTP or HTTPS. An advantage of the described protocol lies in its adaptability to bridge the gap between IaC and CMDB, enabling bidirectional message transcription and parsing between both sides, supporting diverse and complex messages and the unique characteristics of both sides.

According to some aspects, the present disclosure defines a set of new message exchange mechanisms, configuration structures, syntax formats, and scalable template schemas to implement the message exchange protocol disclosed herein. The message exchange protocol covers asset configurations, resource definitions, topology hierarchy, and organizational structures within CMDB, as well as resource declarations and configuration codes within IaC.

According to some aspects, the present disclosure devises the fundamental components that leverage the parser, lexer, and transcriber to implement execution mechanisms and state synchronization for the protocol.

According to some aspects, the present disclosure achieves a Single Source of Truth (SSoT) through transcribing/parsing CMDB configurations from the SaaS layer into IaC code, automating IaaS resources, and synchronizing changes from IaaS back to SaaS. All infrastructure data is mastered solely in the CMDB, which serves as the SSOT master, providing data normalization into a canonical form.

According to some aspects, the protocol described in the present disclosure achieves message transcription, parsing, and communication between CMDB and IaC, reducing manual errors and enhancing automation, reliability, consistency, accuracy, and efficiency within infrastructure management. By incorporating CMDB into code management, the protocol of the present disclosure provides comprehensive automation and programmability for CMDB, leading to more efficient, reusable, and collaborative IT resource management, thereby achieving uniformity of configurations across diverse cloud environments.

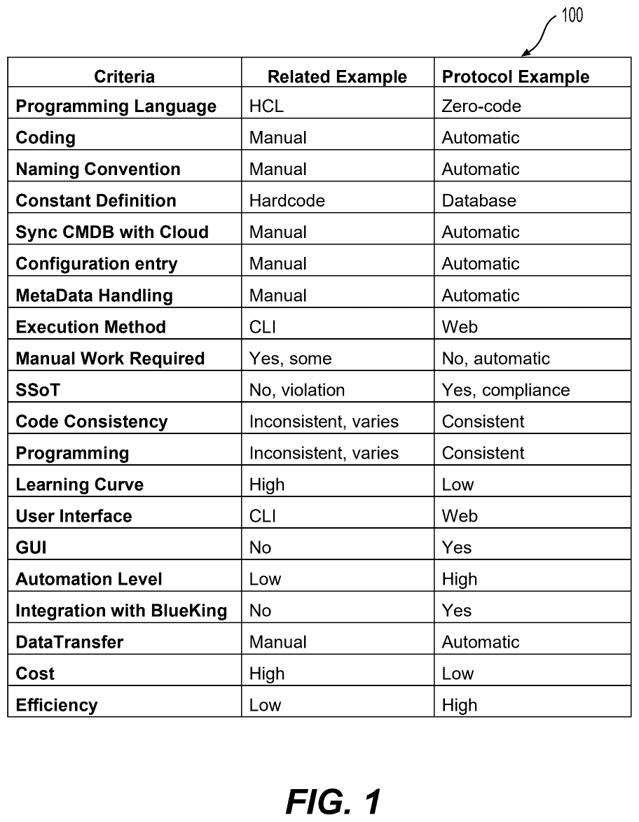

FIG. 1 is a comparison table (100) that compares a related example with a protocol example according to some aspects of the present disclosure.

The related example shown in FIG. 1 involves manually writing IaC code, manually creating cloud resources, manually entering message into CMDB, and manually synchronizing CMDB with cloud resources. The protocol example described in FIG. 1 automates these processes and introduces a more efficient and low-cost solution. It not only capitalizes on the intuitive efficiency proffered by the GUI, but also relies on the flexibility and version control of the code to obviate the inefficiencies and non-standardization of handwritten code.

FIG. 1 outlines the advantages of the protocol described in the present disclosure across various criteria, including automating previously manual functions such as coding, naming conventions, and synchronization of CMDB with the cloud. Among other criteria and advantages, the protocol example also allows the CMDB to function as the SSoT for the system, which decreases the potential of inconsistencies and mistakes and simplifies version control.

As shown in FIG. 1, the protocol example provides a web-based GUI that enables users to visually manage and customize the synchronization process between CMDB and an IaC configuration language file, for example in Terraform. Throughout the present disclosure, Terraform is used as an example of an IaC configuration language file or IaC configuration code. However, the present disclosure is not limited to Terraform and other IaC configuration languages may be used. The protocol example uses a lexer and a parser, in conjunction with LoneSail architecture, to implement functions such as editing, testing, log viewing, and configuring IaC settings.

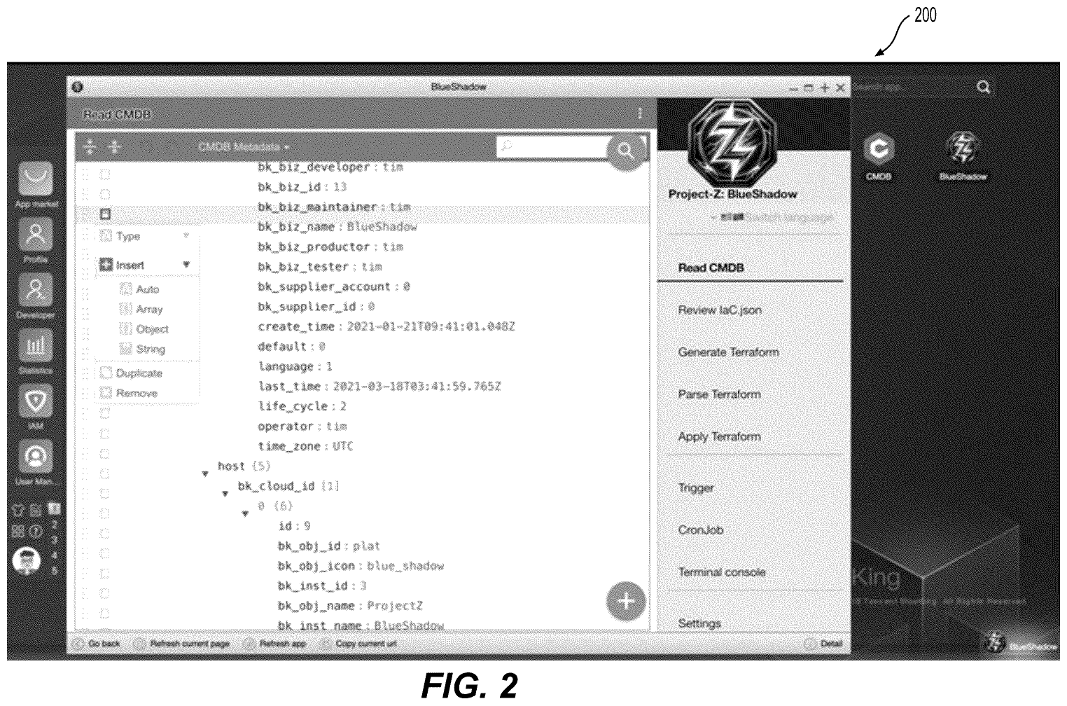

FIG. 2 is a screenshot illustrating a user interface (200) of a platform for managing CMDB metadata according to the protocol example.

As shown in the menu on the right side of the user interface of FIG. 2, the platform allows management and translation of CMDB data into Terraform. The platform may use the RESTful API to read data from the CMDB and generate an IaC.json file. The platform also allows users to mark and identify superfluous CMDB metadata, thereby providing a streamlined approach for configuring mapping rules. This feature can help ensure that the translation between Terraform and CMDB is not only efficient but also precise, adhering to the pre-defined mapping criteria. Additionally, users may make infrastructure configuration changes through the platform shown in FIG. 2 to modify the resources used through the IaaS service.

Before the actual implementation of these modifications, the platform presents users with the opportunity to preview the Terraform code that results from translating the IaC.json file, along with any infrastructure configuration modifications introduced through the platform by the user. This functionality allows users to ensure that their modifications, as reflected in the translated Terraform code, align with intended objectives, to confirm the integrity and accuracy of the data being synchronized between CMDB and Terraform.

Once the Terraform is previewed and confirmed by the user, the platform allows the user to parse and apply the Terraform, which results in providing the Terraform to an IaaS provider in order to provide the infrastructure services described in the Terraform code.

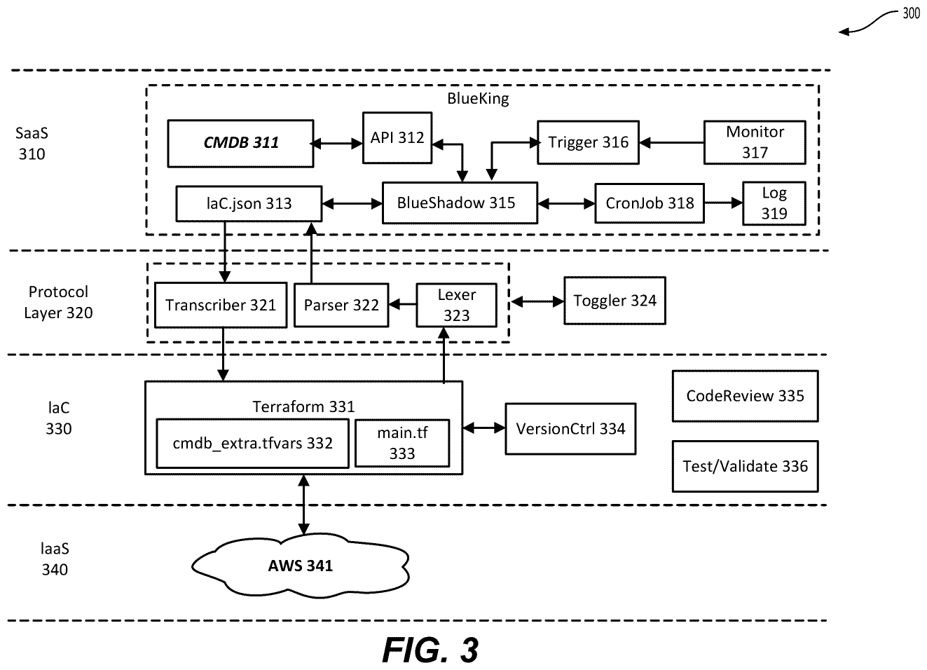

FIG. 3 is a diagram of a computing architecture (300) including a software as a service (SaaS) layer (310), a protocol layer (320), an infrastructure as code (IaC) layer (330), and an infrastructure as a service (IaaS) layer (340).

In some examples, the SaaS layer (310) is configured to provide software components for the platform shown in FIG. 2. For example, the SaaS layer (310) includes CMDB component (311), API component (312), IaC.json component (313), BlueShadow component (315), Trigger component (316), Monitor component (317), CronJob component (318) and Log component (319).

In some examples, the protocol layer (320) includes Transcriber component (321), Parser component (322), Lexer component (323), and Toggler component (324).

In some examples, the IaC layer (330) includes Terraform component (331), VersionCtrl component (334), CodeReview component (335) and Test/Validate component (336). The Terraform component (331) includes cmdb_extra.tfvars (332) and main.tf (333).

In FIG. 3, the IaaS layer (340) is implemented based on Amazon web services (AWS) (341). However, other providers, such as IaaS providers, may be used.

Initially, configuration data is fetched from the CMDB using the RESTful API, initiated by one of three methods: manually on-demand, event-driven triggers, or at predetermined intervals. Examples of triggers include CI/CD events or updates to the IaC configuration settings. The data is then previewed through the platform GUI shown in FIG. 2, culminating in the generation of an ‘IaC.json’ file.

Next, the transcriber (321) converts the ‘IaC.json’ file into ‘main.tf’ (333) and ‘cmdb_extra.tfvars’ (332) files, which are Terraform (331) files. The IaC.json file may be considered infrastructure configuration parameters that are then converted to Terraform files, which may be considered as infrastructure-as-code configuration language files. Any updates represented by these files are meticulously logged under version control to facilitate tracking of changes. Consequently, fault tolerance is achieved through code review (335), error detection mechanisms (such as test/validate 336), logging, and rollbacks to identify data inconsistencies and conversion errors.

Finally, upon applying Terraform by forwarding the file to the IaaS layer (340), output-definitions are returned from the IaaS layer (340) which confirm that the infrastructure configurations represented by the Terraform (331) files have been implemented. The output-definitions may be considered provisional infrastructure-as-code parameters prior to being stored in the CMDB. The output-definitions are fed back into the CMDB through the IaC layer (330) and the Lexer (323) via a RESTful API local-exec provisioner.

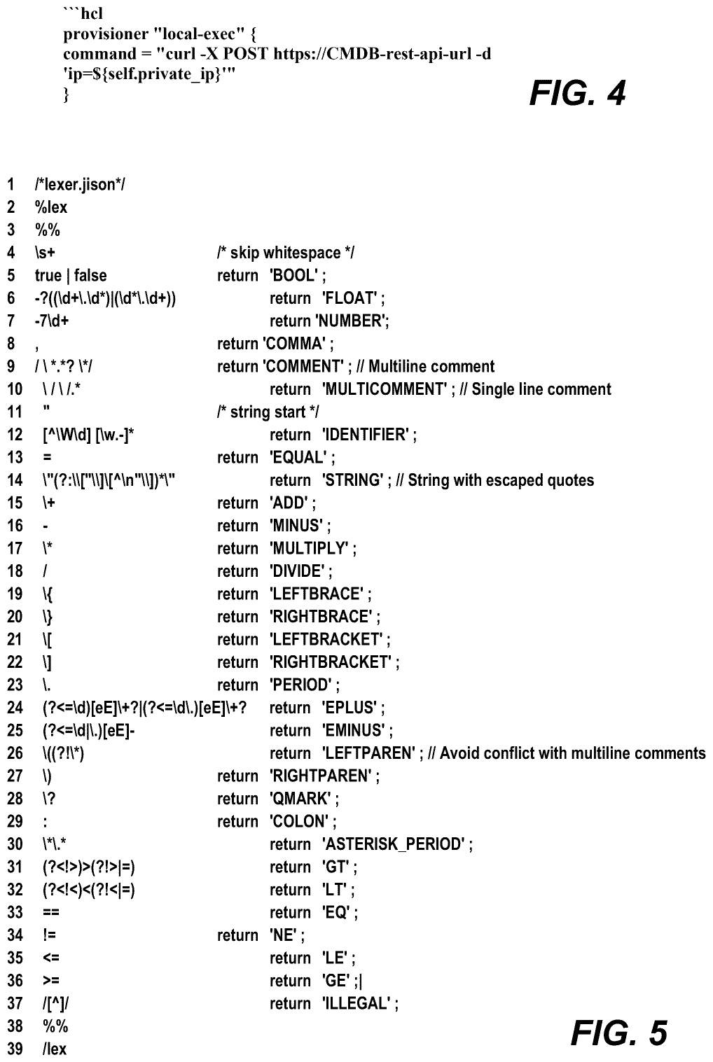

FIG. 4 shows a portion of code showing that, once infrastructure changes are applied via Terraform, the output-definitions are fed back into the CMDB via a RESTful API local-exec provisioner. In some examples, the SSoT architecture mandates that any updates made in the IaaS layer are considered provisional until they are effectively synchronized with the CMDB.

After the output-definitions are received from the IaaS layer (340), the Lexer (323) identifies raw Terraform HCL code by regular expression patterns, converting it into a structured stream of tokens which represent discrete elements within the Terraform HCL syntax. The Parser (322) constructs a parse tree or an equivalent message structure representing the syntactic schema of the Terraform HCL code from these tokens. The Parser (322) is capable of handling nested structures and various message types in Terraform HCL and interpret complex Terraform code into a JSON format for direct utilization by the CMDB (311).

Overall, the protocol of the present disclosure is a communication protocol that allows for bilateral transfer of messages between the IaaS layer (340) and the CMDB (311), which serves as the SSOT regarding infrastructure resources provided by the IaaS layer (340). According to some aspects of the disclosure, the message exchange mechanism of the protocol is underpinned by four features, such as the Lexer component (323), Parser component (322), Transcriber component (321), and Toggler component (324) in FIG. 3.

According to an aspect of the disclosure, the Lexer component (323) includes protocol regular expression patterns for Terraform. FIG. 5 shows an example of the Lexer component (323) that uses regular expression patterns to process Terraform HCL.

In some examples, the Lexer component (323) tokenizes the input Terraform HCL code. Regular expression patterns define the rules for identifying different tokens. For example, as shown in FIG. 5, the rule for a float type is defined to capture optional negative signs and decimal numbers. The Lexer component (323) breaks down the Terraform HCL code into a series of tokens (like ‘BOOL’, ‘FLOAT’, ‘NUMBER’, etc.) based on regular expression patterns defined for each token, to handle message type discrepancies and hierarchy differences.

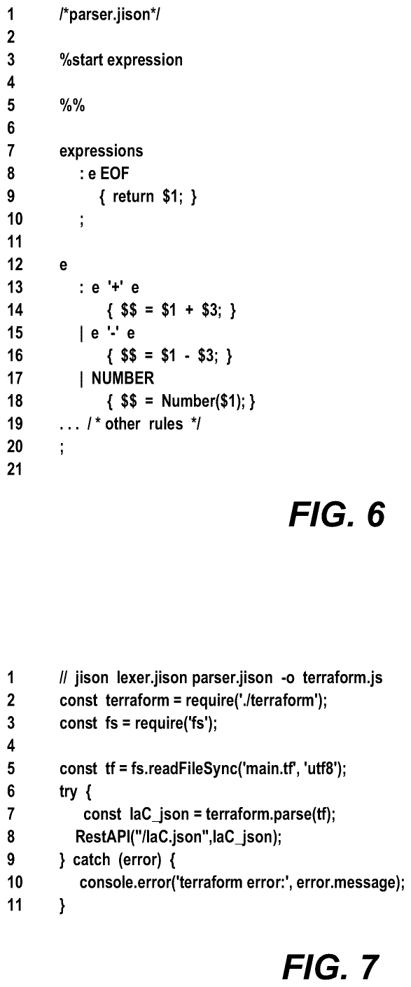

According to an aspect of the disclosure, the Parser component (322) includes protocol parser grammar for Terraform. FIG. 6 shows an example Parser component (322) that defines rules that dictate how tokens can be combined to form valid syntactic constructs.

In some examples, the protocol parser grammar, an example of which is shown in FIG. 6, defines a set of grammar rules that dictate how tokens can be combined to form valid syntactic constructs in Terraform HCL code. The Parser component (322) includes functions to handle complex message structures in Terraform HCL code, such as lists, objects, and nested structures. In some examples, the Parser component (322) has well-defined rules for handling key-value pairs, blocks, and other Terraform HCL-specific structures to ensure that the IaC code (i.e., the IaC.json file generated by the Parser component (322)) is compatible with the format required by the CMDB. In cases where an infrastructure configuration language other than Terraform HCL is used, the Transcriber component (321), the Parser component (322), and the Lexer component (323) are configured to be convert the appropriate infrastructure configuration language to/from the IaC.json file compatible with the format required by the CMDB. When the Parser component (322) converts an infrastructure configuration language such as Terraform to the IaC.json file, the resulting IaC.json file may be considered as updated infrastructure configuration parameters.

In some examples, infrastructure setup details defined in Terraform are not reflected in the CMDB. Therefore the IaC.json file may be used to store Terraform information including, but not limited to, regions, VPC, subnets, AZs, security groups, key pairs, and instance types, that correspond to the attributes of each infrastructure element. FIG. 7 shows an example of code converting Terraform syntax to CMDB in an aspect of the disclosure. This conversion allows for updating the CMDB with infrastructure configuration changes that have been implemented and confirmed from the IaaS layer (340).

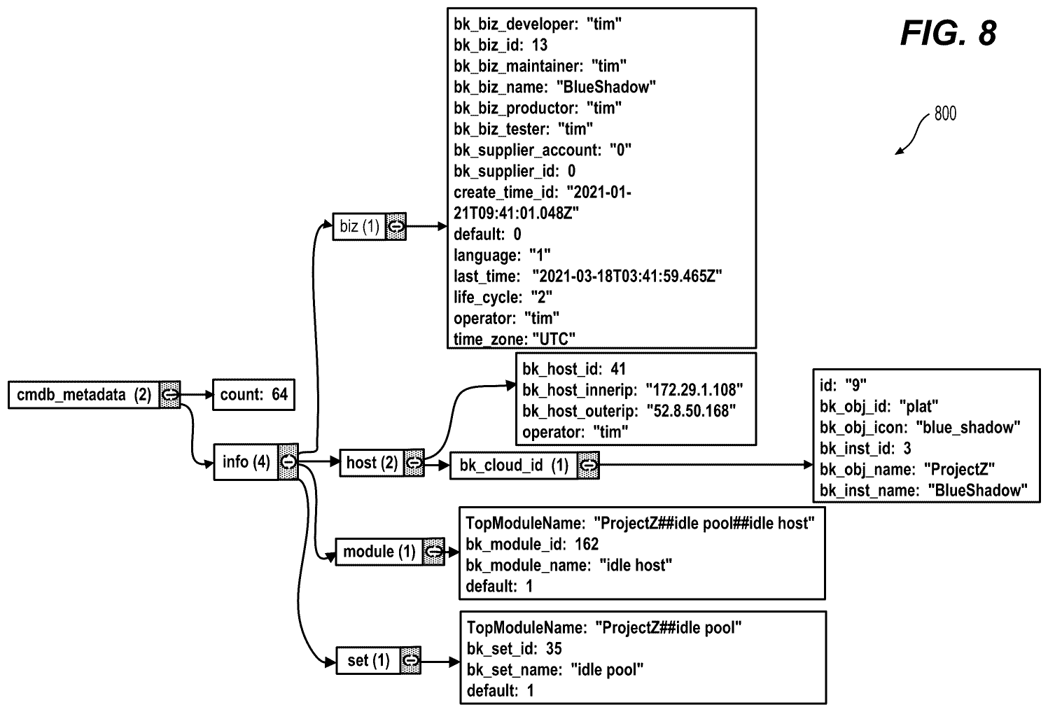

According to an aspect of the disclosure, the Transcriber component (321) converts CMDB metadata to Terraform, as part of converting the IaC.json file (313) to Terraform (331). FIG. 8 is a diagram of an example of CMDB metadata structure from RESTful API in an aspect of the disclosure.

In some examples, CMDB encapsulates comprehensive details of IT assets and configurations, whereas IaC (i.e., Terraform) primarily focuses on the automated deployment of infrastructure. While CMDB provides an organized view of configurations and the relationships between IT assets, CMDB lacks direct integration with IaC codes such as Terraform. That is, a problem solved by the present disclosure is that CMDB houses data types not inherently contained within IaC (Terraform), such as granular infrastructure information—maintenance records, ownership, histories of Service Level Agreements (SLAs), incident, organizational structure details, topologies, usage statistics of assets, departments, teams, roles, users, and custodians of IT assets. On the other hand, IaC (Terraform) is focused on the efficient deployment of cloud infrastructure, including server configurations, network settings, and cloud resource allocation, not addressing the detailed operational management and organizational structure data mentioned above. Accordingly, ensuring that CMDB can serve as the SSoT regarding infrastructure configurations defined in Terraform requires a thoughtful conversion mechanism of the Terraform corresponding to the resources provided by the IaaS layer (340). The advantage of the present disclosure is that the components of the protocol layer (320) are configured to perform the required conversion.

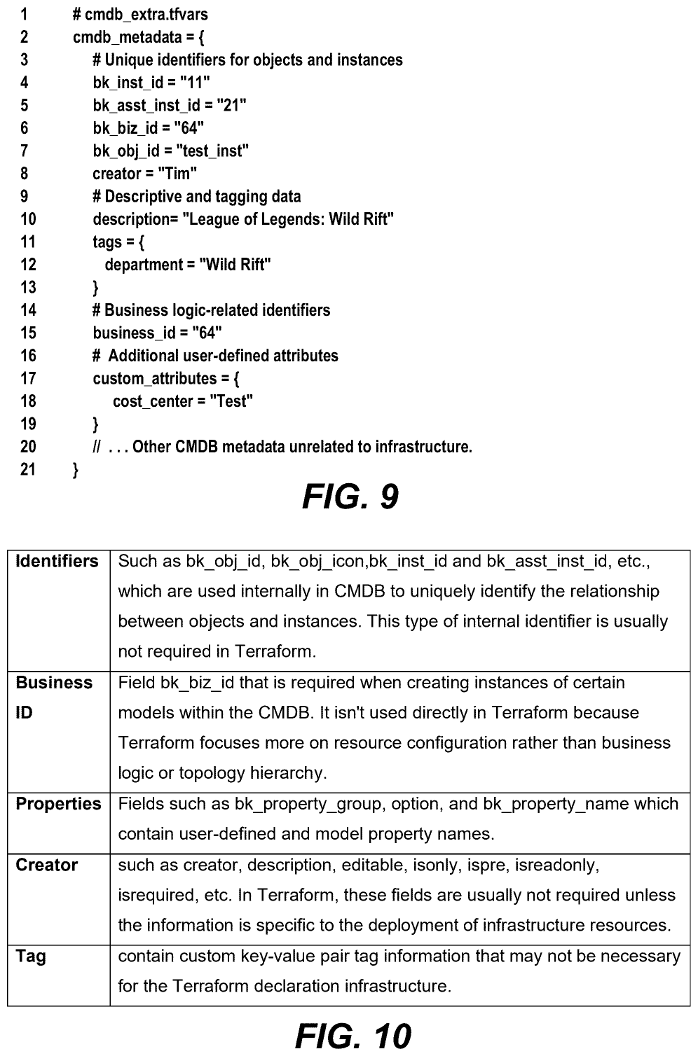

FIG. 9 shows an example of “cmdb_extra.tfvars” protocol message structure definition in an aspect of the disclosure.

In FIG. 9, the protocol introduces an extensible and configurable IaC mapping schema, “cmdb_extra.tfvars” (e.g., cmdb_extra.tfvars component (332) in FIG. 3), to transcribe CMDB metadata, when synchronizing messages from CMDB to IaC (Terraform). The protocol utilizes custom metadata fields and sections, a feature that is supported to identify the CMDB metadata lacking direct correspondence in Terraform. The metadata is then transposed into additional variable files within Terraform, and kept alongside the Terraform configuration, obviating the need for integration of the un-mappable CMDB metadata into the main.tf files (e.g., main.tf component (333) in FIG. 3). Using the extensible and configurable IaC mapping schema (such as the cmdb_extra.tfvars component (332)) allows for storage of additional information from the CMDB within the IaC environment. That is, the main.tf component (333) and the cmdb_extra.tfvars component (332), in combination, allow for all CMDB data to be encapsulated in Terraform (331).

FIG. 10 shows an example of fields and field definitions in the cmdb_extra.tfvars component (332) in an aspect of the disclosure.

In FIG. 10, extensive use of fields and variables not only enables a high degree of configurability, but also preserves the integrity of the CMDB data while aligning with Terraform's IaC paradigm. In an example, the dynamic mapping schema can be tailored to meet the specific requirements of different cloud architectures in real-time based on specific configurations, thereby maintaining consistent definition conventions across diverse clouds while adapting to the infrastructure configuration data that needs to be transferred between the CMDB and the IaaS layer (340).

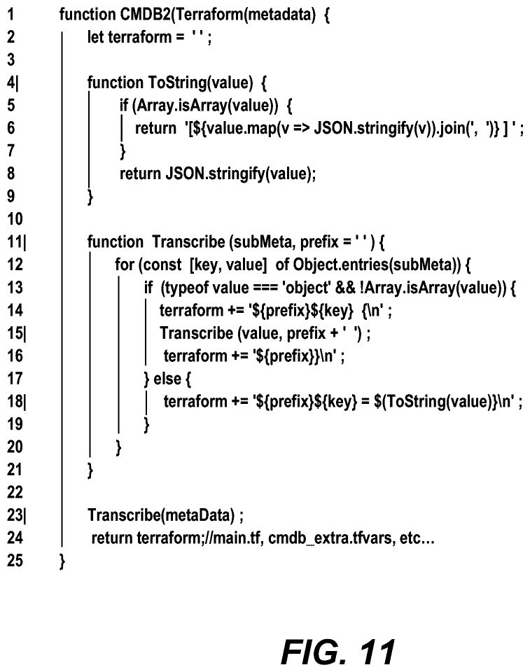

FIG. 11 shows an example code that transcribes CMDB metadata to Terraform in an aspect of the disclosure. As shown in FIG. 11, converting CMDB metadata to Terraform syntax (HCL) can be performed by recursively processing each property of the CMDB metadata and formatting according to the syntax of Terraform.

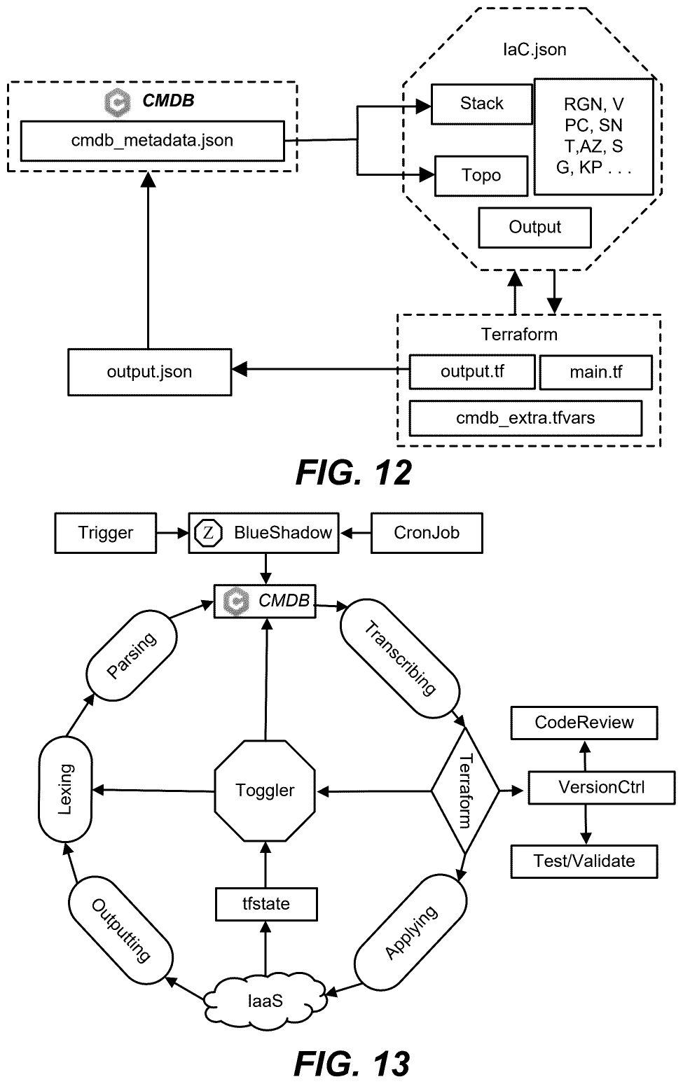

FIG. 12 shows an example of protocol message file conversion sequence in an aspect of the disclosure. The circular flow of FIG. 12 corresponds to a downward and upward movement of messages in FIG. 3. For example, the infrastructure data is initially read out of the CMDB and converted into an IaC.json file. The IaC.json file is then converted into several Terraform files by the protocol layer (320). Once the Terraform is deployed through the IaaS layer (340), the output.json file resulting from the implementation is fed back into the CMDB to synchronize CMDB with the deployed infrastructure resources.

According to an aspect of the disclosure, the Toggler component (324) includes protocol state reconciliation mechanism.

In some examples, the Toggler component (324) is tasked with regular tracking and synchronization the current conversion state, resource state, configuration state, and historical state records of the protocol. That is, the Toggler component (324) controls the various functions shown in FIGS. 12 and 13. For example, the Toggler component (324) initiates the reading of configuration data from the CMDB (for example, based on various triggers) and may further control the subsequent conversions and updates described above with respect to FIG. 12.

FIG. 13 shows an example of Toggler and state control mechanism in an aspect of the disclosure. The visualization of FIG. 13 represents the circular progression of states beginning with reading infrastructure configuration data from the CMDB, transcribing (i.e., the Transcribing state) the data read from the CMDB into Terraform.

At this stage in the state progression, changes may be made to the Terraform in order to make modifications to the infrastructure configuration. In light of such modifications, functions like code review, version control, and test/validation may be applied to ensure that the modified Terraform meets consistency and conformance requirements.

Thereafter, the modified Terraform configuration is applied (i.e., the Applying state) to the IaaS layer (340), which outputs (i.e., the Outputting state) a confirmation of the applied infrastructure configurations. The output of the IaaS layer (340) is then converted (i.e., the Lexing state and the Parsing state) into a state that may be stored back into the CMDB to complete the cycle of making modifications to infrastructure settings, applying such modifications, and updating the CMDB to reflect the modified infrastructure settings.

In some examples, the Toggler component (324) defines the dependencies between resources to determine the sequence and timeframe of movement among the above-described states and functions.

In some examples, the Toggler component (324) employs a state-locking mechanism to prevent concurrent modifications that could lead to conflicts and inconsistencies, to enhance the efficiency and integrity of the protocol.

As illustrated in the FIG. 13, the protocol encompasses eight distinct states, with the initiation and conclusion of each state being regulated by the Toggler component (324).

In some examples, upon the completion of a state, the Toggler component (324) is notified to transition to the subsequent state, thereby ensuring a seamless and orderly progression through the protocol's operations.

Some aspects of the disclosure also provide standards for the IaC.json file. For example, the IaC.json component (313) in FIG. 3 is an IaC.json file having a format that may include, but is not limited to, the following 8 attributes. According to a first aspect, a meta object contains metadata like version, creator, date, intent, purpose, business, scope, goal, and/or etc. According to a second aspect, a stack is an array of infrastructure resources to be created, each specifying infra type, properties, and/or dependencies. According to a third aspect, topo is a topology representation of the business, module, set, and/or host. According to a fourth aspect, a field attribute outlines customizable variables with type, default values, descriptions, and/or constraints. According to a fifth aspect, a rule attribute covers validations, security and/or compliance requirements. According to a sixth aspect, a scene attribute includes scenario-specific configurations to associate keys with corresponding values depending on environment and/or condition. According to a seventh aspect, a script includes embedded and/or linked automation scripts for setup and teardown, including conditional logic for resource creation. According to an eighth aspect, an output attribute specifies output values from the IaaS.

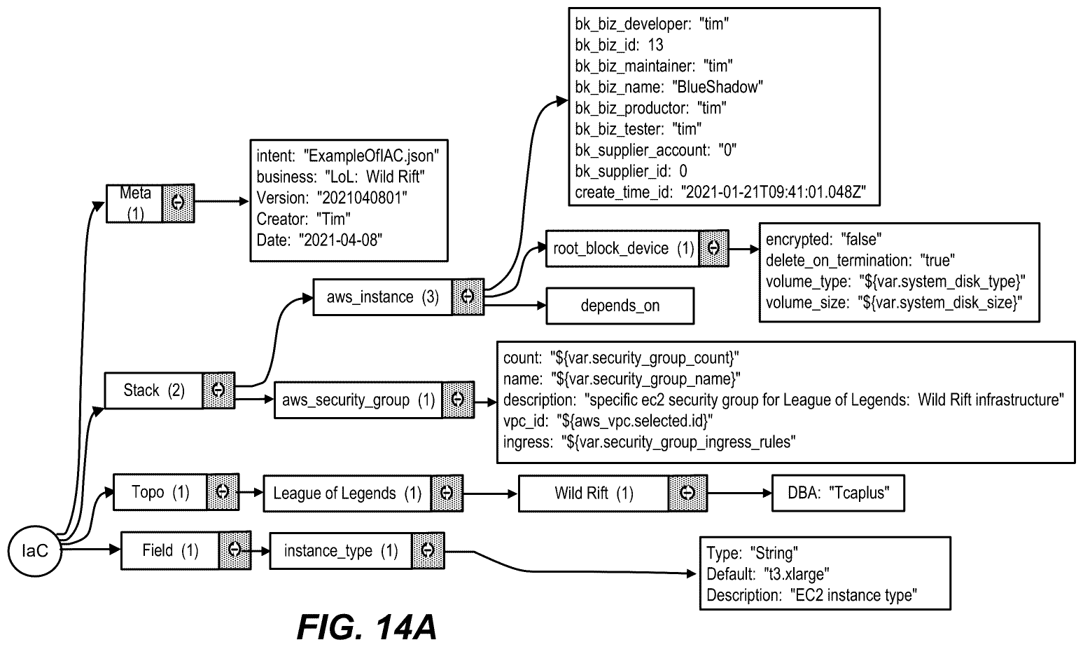

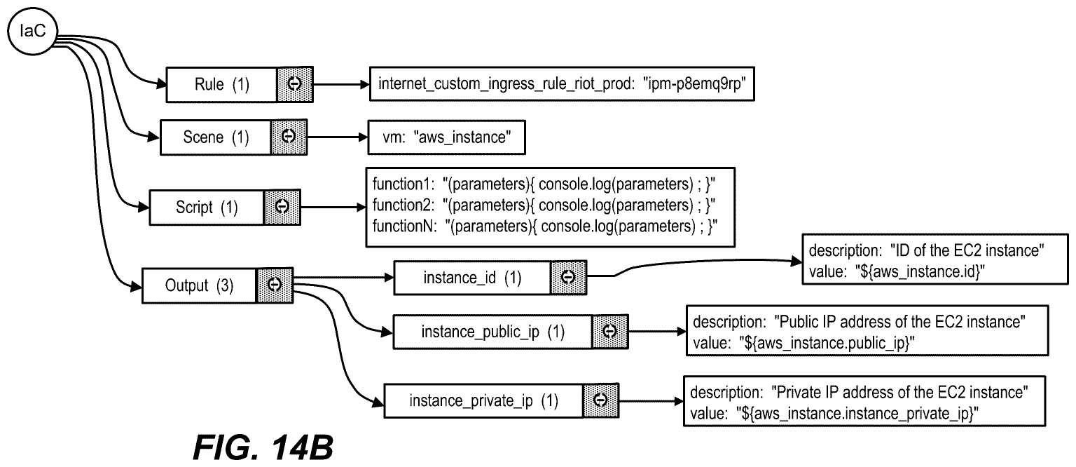

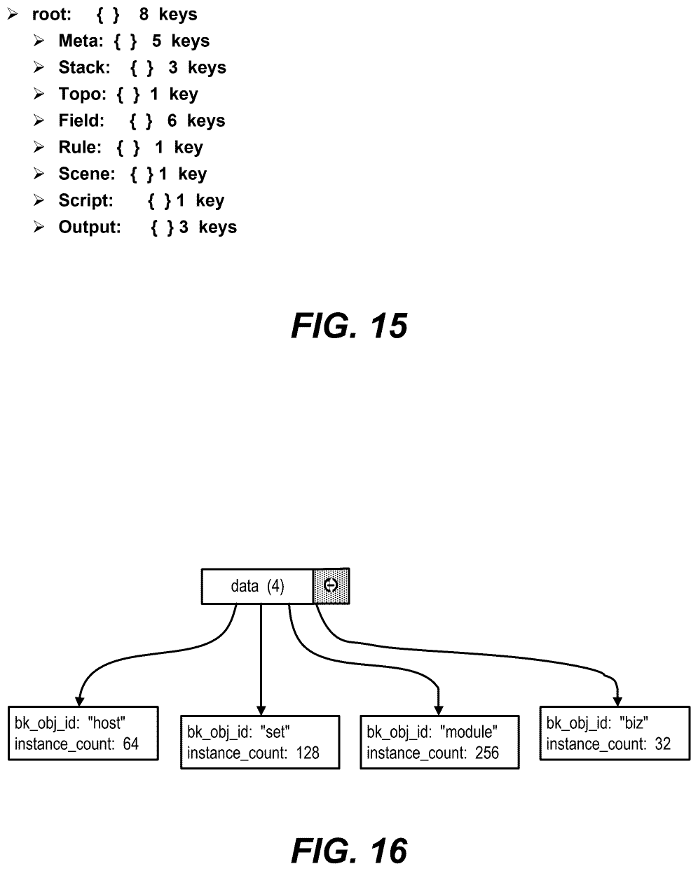

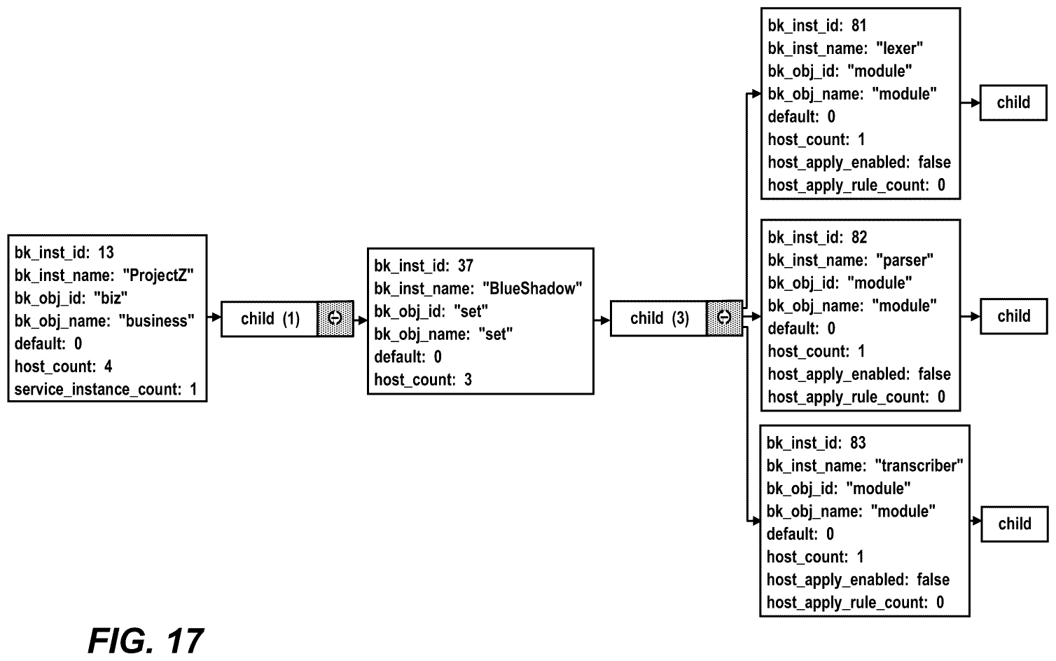

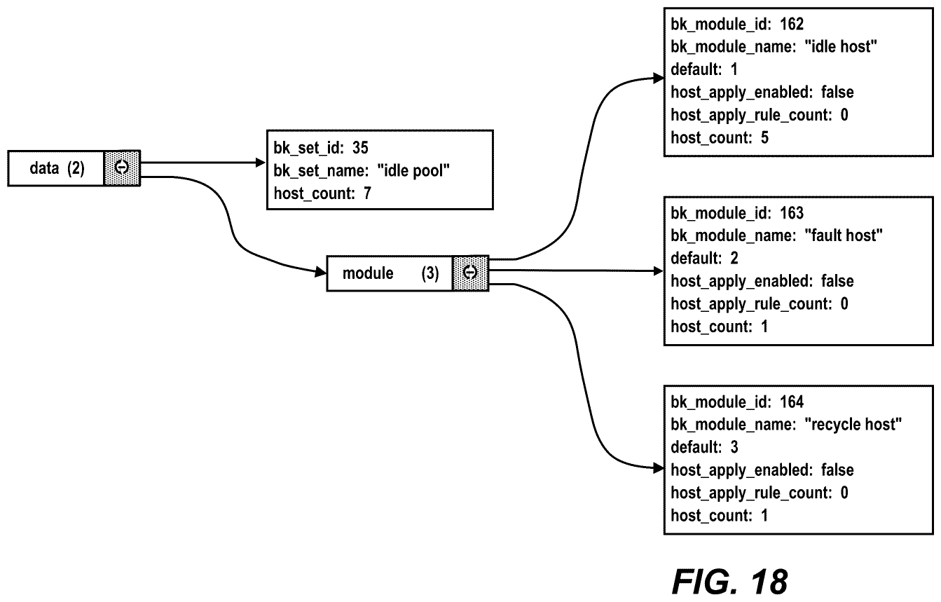

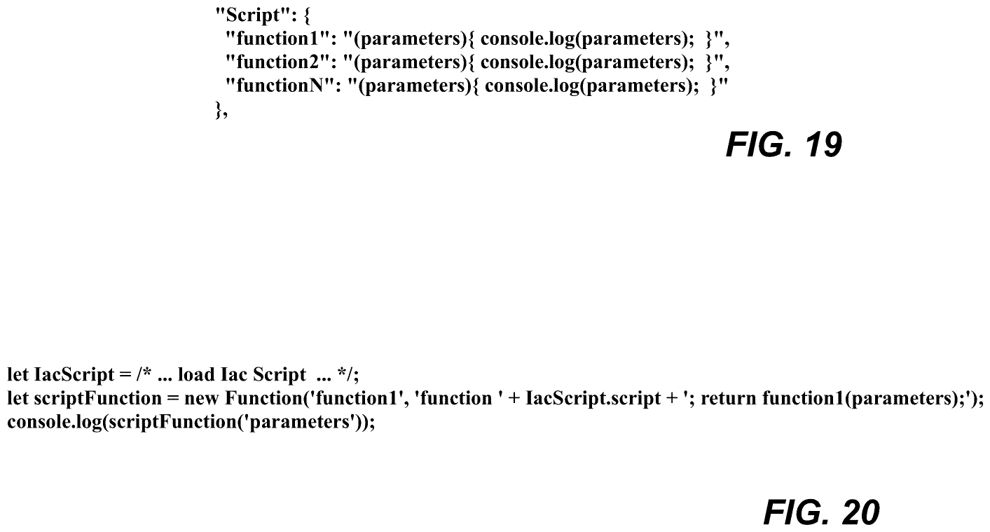

FIGS. 14A, 14B, and 15-18 are diagrams of the structural composition of various aspects according to the disclosure. For example, FIGS. 14A and 14B show a schema example of the IaC.json file format. FIG. 15 shows the above-described aspects that may be found in an IaC.json file. FIG. 16 shows an example schema portion corresponding to a data object within the IaC.json file format. FIG. 17 shows a hierarchical schema structure corresponding to the protocol described in the present disclosure, including lexer, parser, and transcriber components. FIG. 18 shows an example schema portion corresponding to a data object. FIG. 19 shows an example of IaC.json script definition method according to an aspect of the disclosure. FIG. 20 shows an example of IaC.json script execution method according to an aspect of the disclosure.

In some examples, the IaC.json file format shown in FIGS. 14-16, 19, and 20 is designed to provide a comprehensive methodology for the definition and management of cloud resources, ensuring systematic deployment and maintenance within cloud infrastructure environments. That is, the IaC.json file format is configured to support, within a single format structure, various IaaS providers, CMDB implementations, and configuration and metadata settings.

The present disclosure includes techniques for protocol design in cloud computing. In some examples, a protocol designed according to the present disclosure defines a set of communication standards, facilitating communication between SaaS, including CMDB, and IaaS.

Some aspects of the disclosure define protocol standards. In some examples, the protocol standards include a message exchange mechanism. The protocol standards define a set of message exchange mechanisms, including configuration structures, syntax formats and extensible template schemes, such as an ‘IaC.json’ and an ‘cmdb_extra.tfvars’, cover asset configuration, resource definition, topology hierarchy and organizational structure within CMDB.

In some examples, the protocol standards include Parsing, Lexing, and Transcription mechanisms. For example, the protocol standards include parser, lexer and transcriber components to achieve conversion between Terraform HCL code and JSON format that is used directly by the CMDB.

In some examples, the protocol standards include a state control mechanism. The protocol standards define dependencies between resources to determine the order and time frame for creating, updating, configuring, and/or deleting resources. For example, the protocol standards include a toggler for tracking and synchronizing the messages of the protocol passing between the CMBD and the IaaS layer (340).

Some aspects of the disclosure define communication specifications. For example, the communication specifications may be configured to use RESTful API over HTTP/HTTPS for message exchange between IaaS and SaaS (CMDB). For example, the RESTful API may be used to get configuration data from the CMDB and update the CMDB with Terraform results through local-exec curl RESTful API.

In some examples, the communication specifications are configured for message consistency and integrity. The communication specifications ensure that messages exchanged between CMDB and IaaS maintain consistency and integrity during transmission and transcription. For example, the communication specifications may utilize web-based GUI such as LoneSail to monitor the process.

In some examples, the communication specifications are configured for version control and logging. For example, all updates may be made under version control so changes can be tracked. The communication specifications can include an error detection mechanism, as well as logging and rollback capabilities to identify data inconsistencies and conversion errors.

In some examples, the communication specifications are configured for security and interoperability. In some examples, the communication specifications adopt encryption and authentication mechanisms to protect the security of data exchange. Through the standards and communication specifications, the protocol provides a comprehensive, automated, and efficient solution for infrastructure management.

According to some aspects of the disclosure, a protocol designed according to the present disclosure offers substantial improvements over the related example in several aspects, such as programming language (Zero-code), automation levels, user interface, consistency to bridge the gap between SaaS and IaC, enhancing automation and efficiency, streamlining operations, reducing manual errors, and improving consistency across cloud environments.

According to an aspect of the disclosure, protocols designed according to the present disclosure can achieve improved protocol interconnectivity. In an example, a protocol designed according to the present disclosure can achieve tangible benefits, such as precision in replicating cloud-native scenarios, demonstrating a 71.43% improvement in accurately mirroring actual cloud environments. This qualitative rate underscores the precision of the synchronization strategy of this protocol. A web-based GUI is introduced for monitoring consistency, reducing inconsistencies by 12.5%. The use of checksums or versioning logs results in an 18% reduction in configuration error rates during synchronization, thereby enhancing operational accuracy by 16.67%.

According to an aspect of the disclosure, protocols designed according to the present disclosure can achieve user experience beneficial effects. In an example, a protocol designed according to the present disclosure obtains user satisfaction surveys on perceived efficiency and case of use that indicate a 42.86% increase in subjective metrics. Feedback from users and practitioners regarding operating efficiency improvements shows a 28.57% qualitative increase in positive feedback. There is a 33.33% reduction in steps and time consumption when completing the same task. The learning curve is reduced by 45% when benchmarking against manual IaC. With a more intuitive, user-friendly GUI, there is a 25% increase in the rate of tasks requiring precise input, improving operational case and accuracy by 16.67%. User convenience facilitates a 57.14% improvement in task execution efficiency.

According to an aspect of the disclosure, protocols designed according to the present disclosure can achieve performance beneficial effects. In an example, by conducting a series of controlled experiments to measure deployment speed, quantitative data indicates a 66.67% reduction in the time required for infrastructure deployment. For instance, tasks that conventionally took an hour can now be accomplished in 20 minutes. A comparison of manual vs. automated configuration accuracy reveals that automated methods are 14.29% more accurate.

According to an aspect of the disclosure, protocols designed according to the present disclosure can achieve SSOT beneficial effects. In an example, a protocol designed according to the present disclosure provides SSOT normalization, directing all read and update operations to the CMDB, which serves as the SSOT master. The SSoT, also referred to as a golden record, has beneficial effects that include reduced redundancy, simplified version control, enhanced consistency, accuracy, reliability, enhanced decision-making precision, cost savings, increased efficiency, improved accountability, support for compliance and governance, objective alignment within an organization, mitigates risks associated with data discrepancies and inconsistencies, reduces errors arising from the usage of various data sources (such as CMDB and IaC) across different organizational divisions, and eliminates data silos. It scales effectively with organizational growth and bolsters stakeholder confidence, thereby enhancing overall operational performance.

According to an aspect of the disclosure, protocols designed according to the present disclosure can achieve cost-benefit effects. In an example, long-term quantification in cost-benefit analysis indicates a 33.33% cost reduction compared to traditional methods.

It is noted that, while Terraform is used as an example to illustrate the protocol design techniques, the protocol design techniques can be applied to other suitable applications, for example Ansible, Puppet, and CloudFormation, among others.

In an example, in Ansible, variables within Playbooks can store relevant CMDB data, such as software versions and configuration parameters. Ansible Facts can be leveraged to collect and update system information in alignment with CMDB. In another example, Puppet offers node definitions and the Facter tool for integrating CMDB data, including role and environment settings of machines. In another example, in CloudFormation, resource properties and metadata sections within templates can store additional CMDB data, thereby ensuring detailed recording and tracking of infrastructure configurations. This method maintains synchronization between CMDB data and IaC, improving accuracy and transparency in configuration management.

According to an aspect of the disclosure, a protocol designed according to the present disclosure obviates the need for the manual coding and scripting hitherto associated with IaC languages through automating the infrastructure provisioning and configuration process. The protocol leverages an IaC.json message file to interface with prevalent IaC code such as Terraform, Ansible, Puppet, and CloudFormation in order to maintain and update a consistent, synchronized infrastructure management strategy.

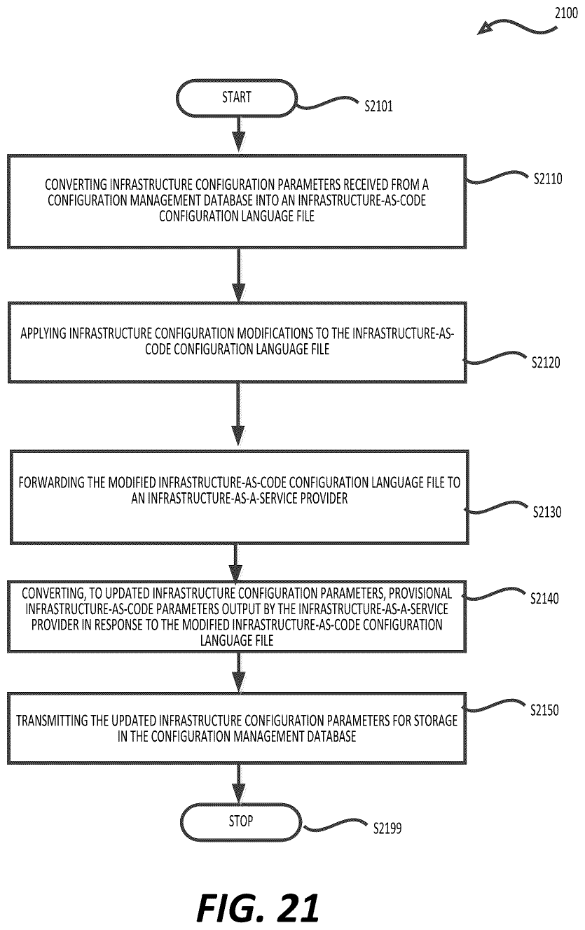

FIG. 21 shows a flow chart outlining a process (2100) according to an aspect of the disclosure. In various aspects, the process (2100) is executed by processing circuitry. In some aspects, the process (2100) is implemented in software instructions, thus when the processing circuitry executes the software instructions, the processing circuitry performs the process (2100). The process starts at (S2101) and proceeds to (S2110).

At (S2110), infrastructure configuration parameters received from a configuration management database are converted into an infrastructure-as-code configuration language file. In an example, the infrastructure-as-code configuration language file is generated based on infrastructure configuration parameters. The infrastructure configuration parameters is obtained from a configuration management database, for example.

At (S2120), infrastructure configuration modifications are applied to the infrastructure-as-code configuration language file.

At (S2130), the modified infrastructure-as-code configuration language file is forwarded to an infrastructure-as-a-service provider.

At (S2140), provisional infrastructure-as-code parameters output by the infrastructure-as-a-service provider are converted to updated infrastructure configuration parameters, in response to the modified infrastructure-as-code configuration language file. In an example, updated infrastructure configuration parameters are generated based on provisional infrastructure-as-code parameters output by the infrastructure-as-a-service provider. The infrastructure-as-a-service provider outputs the provisional infrastructure-as-code parameters based on the modified infrastructure-as-code configuration language file

At (S2150), the updated infrastructure configuration parameters are transmitted for storage in the configuration management database.

Then, the process proceeds to (S2199) and terminates.

The process (2100) can be suitably adapted. Step(s) in the process (2100) can be modified and/or omitted. Additional step(s) can be added. Any suitable order of implementation can be used.

In an aspect, the conversion of the infrastructure configuration parameters is performed by parsing and transcribing the infrastructure configuration parameters stored in the configuration management database into the infrastructure-as-code configuration language file.

In an aspect, the conversion of the provisional infrastructure-as-code parameters is performed by parsing and transcribing provisional infrastructure-as-code parameters output by the infrastructure-as-a-service provider into the updated infrastructure configuration parameters.

In an aspect, the infrastructure-as-code configuration language file is, or includes, a Terraform file.

In an aspect, the configuration management database is, includes, or is part of a software-as-a-service platform. In an example, the configuration management database includes CMDB (311), which is a part of the SaaS (310) layer, as illustrated in FIG. 3.

In an aspect, the infrastructure configuration parameters received from a configuration management database include at least one of asset configuration parameters, resource definition parameters, topology hierarchy parameters, or organizational structure parameters.

In an aspect, infrastructure configuration parameters stored in the configuration management database are a single source of truth (SSOT) of infrastructure data.

In an aspect, the infrastructure-as-code configuration language file is displayed in a graphical user interface (GUI). The infrastructure configuration modifications are received through the GUI.

In an aspect, the conversion of the infrastructure configuration parameters is triggered by at least one of a user request, an event-based trigger, or at a time-based interval.

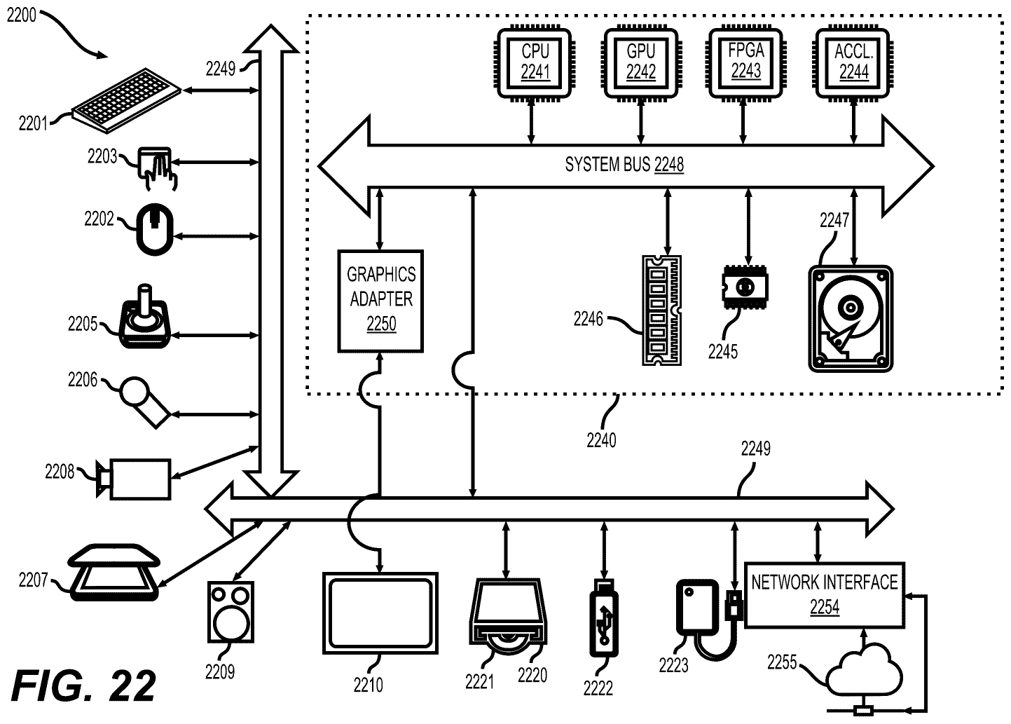

The techniques described above, can be implemented as computer software using computer-readable instructions and physically stored in one or more computer-readable media. For example, FIG. 22 shows a computer system (2200) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 22 for computer system (2200) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (2200).

Computer system (2200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2201), mouse (2202), trackpad (2203), touch screen (2210), data-glove (not shown), joystick (2205), microphone (2206), scanner (2207), camera (2208).

Computer system (2200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2210), data-glove (not shown), or joystick (2205), but there can also be tactile feedback devices that do not serve as input devices), audio output devices (such as: speakers (2209), headphones (not depicted)), visual output devices (such as screens (2210) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (2200) can also include human accessible storage devices and their associated media such as optical media including CD/DVD ROM/RW (2220) with CD/DVD or the like media (2221), thumb-drive (2222), removable hard drive or solid state drive (2223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2200) can also include an interface (2254) to one or more communication networks (2255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2249) (such as, for example USB ports of the computer system (2200)); others are commonly integrated into the core of the computer system (2200) by attachment to a system bus as described below (for example Ethernet interface into a PC computer system or cellular network interface into a smartphone computer system). Using any of these networks, computer system (2200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2240) of the computer system (2200).

The core (2240) can include processing circuitry, such as one or more Central Processing Units (CPU) (2241), Graphics Processing Units (GPU) (2242), specialized programmable processing units in the form of Field Programmable Gate Areas (FPGA) (2243), hardware accelerators for certain tasks (2244), graphics adapters (2250), and so forth. These devices, along with Read-only memory (ROM) (2245), Random-access memory (2246), internal mass storage such as internal non-user accessible hard drives, SSDs, and the like (2247), may be connected through a system bus (2248). In some computer systems, the system bus (2248) can be accessible in the form of one or more physical plugs to enable extensions by additional CPUs, GPU, and the like. The peripheral devices can be attached either directly to the core's system bus (2248), or through a peripheral bus (2249). In an example, the screen (2210) can be connected to the graphics adapter (2250). Architectures for a peripheral bus include PCI, USB, and the like.

CPUs (2241), GPUs (2242), FPGAs (2243), and accelerators (2244) can execute certain instructions that, in combination, can make up the aforementioned computer code. That computer code can be stored in ROM (2245) or RAM (2246). Transitional data can also be stored in RAM (2246), whereas permanent data can be stored for example, in the internal mass storage (2247). Fast storage and retrieve to any of the memory devices can be enabled through the use of cache memory, that can be closely associated with one or more CPU (2241), GPU (2242), mass storage (2247), ROM (2245), RAM (2246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2200), and specifically the core (2240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2240) that are of non-transitory nature, such as core-internal mass storage (2247) or ROM (2245). The software implementing various aspects of the present disclosure can be stored in such devices and executed by core (2240). A computer-readable medium can include one or more memory devices or chips, according to particular needs. The software can cause the core (2240) and specifically the processors therein (including CPU, GPU, FPGA, and the like) to execute particular processes or particular parts of particular processes described herein, including defining data structures stored in RAM (2246) and modifying such data structures according to the processes defined by the software. In addition or as an alternative, the computer system can provide functionality as a result of logic hardwired or otherwise embodied in a circuit (for example: accelerator (2244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects of the disclosure, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method, comprising:
converting infrastructure configuration parameters received from a configuration management database into an infrastructure-as-code configuration language file;
applying infrastructure configuration modifications to the infrastructure-as-code configuration language file;
forwarding the modified infrastructure-as-code configuration language file to an infrastructure-as-a-service provider;
converting, to updated infrastructure configuration parameters, provisional infrastructure-as-code parameters output by the infrastructure-as-a-service provider in response to the modified infrastructure-as-code configuration language file; and
transmitting the updated infrastructure configuration parameters for storage in the configuration management database.

2. The method according to claim 1, wherein the converting the infrastructure configuration parameters is performed by parsing and transcribing the infrastructure configuration parameters stored in the configuration management database into the infrastructure-as-code configuration language file.

3. The method according to claim 1, wherein the converting the provisional infrastructure-as-code parameters is performed by parsing and transcribing the provisional infrastructure-as-code parameters output by the infrastructure-as-a-service provider into the updated infrastructure configuration parameters.

4. The method according to claim 1, wherein the infrastructure-as-code configuration language file includes a Terraform file.

5. The method according to claim 1, wherein the configuration management database is part of a software-as-a-service platform.

6. The method according to claim 1, wherein the infrastructure configuration parameters received from the configuration management database include at least one of asset configuration parameters, resource definition parameters, topology hierarchy parameters, or organizational structure parameters.

7. The method according to claim 1, wherein the infrastructure configuration parameters stored in the configuration management database are a single source of truth (SSOT) of infrastructure data.

8. The method according to claim 1, further comprising:
displaying the infrastructure-as-code configuration language file in a graphical user interface (GUI); and
receiving the infrastructure configuration modifications through the GUI.

9. The method according to claim 1, wherein the converting the infrastructure configuration parameters is triggered by at least one of a user request, an event-based trigger, or at a time-based interval.

10. An apparatus comprising:
processing circuitry configured to
convert infrastructure configuration parameters received from a configuration management database into an infrastructure-as-code configuration language file;
apply infrastructure configuration modifications to the infrastructure-as-code configuration language file;
forward the modified infrastructure-as-code configuration language file to an infrastructure-as-a-service provider;
convert, to updated infrastructure configuration parameters, provisional infrastructure-as-code parameters output by the infrastructure-as-a-service provider in response to the modified infrastructure-as-code configuration language file; and
transmit the updated infrastructure configuration parameters for storage in the configuration management database.

11. The apparatus according to claim 10, wherein the processing circuitry is configured to convert the infrastructure configuration parameters by parsing and transcribing the infrastructure configuration parameters stored in the configuration management database into the infrastructure-as-code configuration language file.

12. The apparatus according to claim 10, wherein the processing circuitry is configured to convert the provisional infrastructure-as-code parameters by parsing and transcribing the provisional infrastructure-as-code parameters output by the infrastructure-as-a-service provider into the updated infrastructure configuration parameters.

13. The apparatus according to claim 10, wherein the infrastructure-as-code configuration language file includes a Terraform file.

14. The apparatus according to claim 10, wherein the configuration management database is part of a software-as-a-service platform.

15. The apparatus according to claim 10, wherein the infrastructure configuration parameters received from the configuration management database include at least one of asset configuration parameters, resource definition parameters, topology hierarchy parameters, or organizational structure parameters.

16. The apparatus according to claim 10, wherein the infrastructure configuration parameters stored in the configuration management database are a single source of truth (SSOT) of infrastructure data.

17. The apparatus according to claim 10, wherein the processing circuitry is further configured to:
display the infrastructure-as-code configuration language file in a graphical user interface (GUI); and
receive the infrastructure configuration modifications through the GUI.

18. The apparatus according to claim 10, wherein the processing circuitry is configured to convert the infrastructure configuration parameters in response to at least one of a user request, an event-based trigger, or at a time-based interval.

19. A non-transitory computer-readable storage medium storing computer-readable instructions thereon, which, when executed by processing circuitry, cause the processing circuitry to perform a method comprising:
converting infrastructure configuration parameters received from a configuration management database into an infrastructure-as-code configuration language file;
applying infrastructure configuration modifications to the infrastructure-as-code configuration language file;
forwarding the modified infrastructure-as-code configuration language file to an infrastructure-as-a-service provider;
converting, to updated infrastructure configuration parameters, provisional infrastructure-as-code parameters output by the infrastructure-as-a-service provider in response to the modified infrastructure-as-code configuration language file; and
transmitting the updated infrastructure configuration parameters for storage in the configuration management database.

20. The non-transitory computer-readable storage medium according to claim 19, wherein the infrastructure configuration parameters stored in the configuration management database are a single source of truth (SSOT) of infrastructure data.
